(19) United States
(12) Patent Application Publication
(10) Pub. No.: US 2023/0193736 A1
(43) Pub. Date: Jun. 22, 2023

(54) INFILL DEVELOPMENT PREDICTION SYSTEM

(71) Applicant: SCHLUMBERGER TECHNOLOGY CORPORATION, Sugar Land, TX (US)

(72) Inventors: Saurabh THAKUR, Houston, TX (US); Supriya GUPTA, Houston, TX (US); Efejera EJOFODOMI, Houston, TX (US); Antonio MASSONI ABINADER, Houston, TX (US); Asim MALIK, Sugar Land, TX (US); Prasanna NIRGUDKAR, Sugar Land, TX (US)

(21) Appl. No.: 18/167,431

(22) Filed: Feb. 10, 2023

Related U.S. Application Data
(63) Continuation of application No. PCT/US2021/071158, filed on Aug. 11, 2021.
(60) Provisional application No. 63/064,067, filed on Aug. 11, 2020.

(51) Int. Cl. E21B 43/30

(52) U.S. Cl. CPC E21B 43/30; E21B 2200/20; E21B 2200/22

(57) ABSTRACT

A method, apparatus, and program product may build parent-child well pairs from data associated with one or more wells in a basin and use one or more parameters associated with such well pairs to train or use a machine learning model to predict a production impact of an infill well on one or more neighboring wells in the basin.

### CROSS REFERENCE PARAGRAPH

This application is a continuation of pending PCT Application No. PCT/US2021/071158, filed on Aug. 11, 2021, which claims the benefit of U.S. Provisional Application No. 63/064,067, entitled “INFILL DEVELOPMENT PREDICTION SYSTEM,” filed Aug. 11, 2020. The contents of the disclosures are hereby incorporated herein by reference in their entirety.

### BACKGROUND

In many unconventional hydrocarbon basins, development initially proceeds by drilling a limited number of wells suitable for covering a particular acreage. These initial wells are sometimes referred to as parent wells. Development thereafter proceeds by drilling additional infill wells, also referred to as child wells, and in many instances, the child wells are subjected to stimulation operations to stimulate production in the infill wells. However, when a child well stimulation operation communicates with a parent well, the result is parent-child well interference, which may be referred to additionally as a frac hit, and such frac hits can have positive, negative, or neutral effects on parent well production. In addition, infill well production generally varies with distance from the parent well, the time elapsed since the parent well began producing, and other factors. Rapid production declines may also occur in parent and child wells after infill well stimulation.

Therefore, a continuing need exists in the art for a manner of predicting the effects of infill wells within a hydrocarbon basin to facilitate practices occurring throughout the life cycles of such wells, including planning, designing, constructing, completing, stimulating and producing hydrocarbons from such wells.

### SUMMARY

The embodiments disclosed herein may provide a method, apparatus, and program product that build parent-child well pairs from data associated with one or more wells in a basin and use one or more parameters associated with such well pairs to train or use a machine learning model to predict a production impact of an infill well on one or more neighboring wells in the basin.

Therefore, consistent with one aspect of the invention, a method may include receiving data associated with a plurality of wells in a basin, building a plurality of well pairs from the received data, where each well pair in the plurality of well pairs matches a pair of wells from among the plurality of wells in a parent-child pair relationship and includes one or more parameters associated with the parent-child pair relationship, and providing the one or more parameters of at least a portion of the plurality of well pairs to a trained machine learning model to predict a production impact of an infill well on one or more neighboring wells among the plurality of wells in the basin.

In some embodiments, the infill well is an existing infill well. Also, in some embodiments, the infill well is a planned infill well. Further, in some embodiments, building the plurality of well pairs includes generating a plurality of candidate well pairs from the plurality of wells, determining one or more pair level parameters for at least a subset of the plurality of candidate well pairs, and filtering the plurality of candidate well pairs using the determined one or more pair level parameters to determine the plurality of well pairs.

In some embodiments, the determined one or more pair level parameters for a first well pair in the plurality of candidate well pairs includes at least one distance parameter describing a distance between the wells in the first well pair, and filtering the plurality of candidate well pairs includes applying a distance filter criterion to accept or reject the first well pair based upon the at least one distance parameter. In addition, in some embodiments, the determined one or more pair level parameters for a first well pair in the plurality of candidate well pairs includes at least one temporal parameter describing a temporal relationship between the wells in the first well pair, and filtering the plurality of candidate well pairs includes applying a temporal filter criterion to accept or reject the first well pair based upon the at least one temporal parameter.

In some embodiments, each of the plurality of well pairs includes a parent well and a child well. In addition, in some embodiments, the one or more parameters associated with the parent-child pair relationship for each of the plurality of well pairs includes a key performance indicator describing production by the parent well before and after completion of the child well. In addition, some embodiments may further include generating one or more neighborhood features describing, for each of a plurality of child wells, a net contribution of each of a plurality of neighboring parent wells to each such child well, and providing the one or more parameters to the trained machine learning model to predict the production impact of the infill well on the one or more neighboring wells further includes providing the one or more neighborhood features to the trained machine learning model.

In some embodiments, receiving the data includes receiving one or more of public data, chemical additives data, reservoir data or proprietary data, and providing the one or more parameters to the trained machine learning model to predict the production impact of the infill well on the one or more neighboring wells further includes providing the one or more of public data, chemical additives data, reservoir data or proprietary data to the trained machine learning model.

Moreover, in some embodiments, receiving the data includes receiving unstructured data, and the method further includes extracting a plurality of tables and/or forms from the unstructured data, matching similar table and/or form headers to aggregate similar tables and/or forms in the plurality of tables and/or forms, and after aggregating similar tables and/or forms in the plurality of tables and/or forms, generating a plurality of rows, with each row including stimulation, drilling and/or geological data from the plurality of tables and/or forms and associated with a single well among the plurality of wells.

In some embodiments, the trained machine learning model includes a production impact model. Some embodiments may also include providing at least a portion of the one or more parameters of at least a portion of the plurality of well pairs to a second trained machine learning model to predict a performance of the infill well. In addition, in some embodiments, the second trained machine learning model includes a well performance model. In some embodiments, each of the plurality of well pairs includes a parent well and a child well, the method further includes, for each of a plurality of child wells, aggregating parent well features for a plurality of parent wells in a neighborhood of such child well into a proxy parent representing a collective impact on such child well, and providing the one or more parameters to the trained machine learning model to predict the production impact of the infill well on the one or more neighboring wells further includes providing one or more proxy parents to the trained machine learning model.

Consistent with another aspect of the invention, a method may include receiving data associated with a plurality of wells in a basin, building a plurality of well pairs from the received data, where each well pair in the plurality of well pairs matches a pair of wells from among the plurality of wells in a parent-child pair relationship and includes one or more parameters associated with the parent-child pair relationship, and using the one or more parameters of at least a portion of the plurality of well pairs to train a machine learning model to predict a production impact of an infill well on one or more neighboring wells among the plurality of wells in the basin.

Moreover, in some embodiments, building the plurality of well pairs includes generating a plurality of candidate well pairs from the plurality of wells, determining one or more pair level parameters for at least a subset of the plurality of candidate well pairs, and filtering the plurality of candidate well pairs using the determined one or more pair level parameters to determine the plurality of well pairs.

Also, in some embodiments, the determined one or more pair level parameters for a first well pair in the plurality of candidate well pairs includes at least one distance parameter describing a distance between the wells in the first well pair, and filtering the plurality of candidate well pairs includes applying a distance filter criterion to accept or reject the first well pair based upon the at least one distance parameter. In some embodiments, the determined one or more pair level parameters for a first well pair in the plurality of candidate well pairs includes at least one temporal parameter describing a temporal relationship between the wells in the first well pair, and filtering the plurality of candidate well pairs includes applying a temporal filter criterion to accept or reject the first well pair based upon the at least one temporal parameter.

In addition, in some embodiments, each of the plurality of well pairs includes a parent well and a child well. Also, in some embodiments, the one or more parameters associated with the parent-child pair relationship for each of the plurality of well pairs includes a key performance indicator describing production by the parent well before and after completion of the child well.

In addition, some embodiments may further include generating one or more neighborhood features describing, for each of a plurality of child wells, a net contribution of each of a plurality of neighboring parent wells to each such child well, and using the one or more parameters to train the machine learning model to predict the production impact of the infill well on the one or more neighboring wells further includes using the one or more neighborhood features to train the machine learning model.

Further, in some embodiments, receiving the data includes receiving one or more of public data, chemical additives data, reservoir data or proprietary data, and using the one or more parameters to train the machine learning model to predict the production impact of the infill well on the one or more neighboring wells further includes using the one or more of public data, chemical additives data, reservoir data or proprietary data to train the machine learning model.

Also, in some embodiments, receiving the data includes receiving unstructured data, and the method further includes extracting a plurality of tables and/or forms from the unstructured data, matching similar table and/or form headers to aggregate similar tables and/or forms in the plurality of tables and/or forms, and after aggregating similar tables and/or forms in the plurality of tables and/or forms, generating a plurality of rows, with each row including stimulation, drilling and/or geological data from the plurality of tables and/or forms and associated with a single well among the plurality of wells.

Further, in some embodiments, the machine learning model includes a production impact model, and the method further includes using at least a portion of the one or more parameters to train a second trained machine learning model to predict a performance of the infill well. In some embodiments, each of the plurality of well pairs includes a parent well and a child well, the method further includes, for each of a plurality of child wells, aggregating parent well features for a plurality of parent wells in a neighborhood of such child well into a proxy parent representing a collective impact on such child well, and using the one or more parameters to train the machine learning model to predict the production impact of the infill well on the one or more neighboring wells further includes using one or more proxy parents to train the machine learning model.

Some embodiments may also include an apparatus including at least one processing unit and program code configured upon execution by the at least one processing unit to perform any of the aforementioned methods. Some embodiments may also include a program product including a computer readable medium and program code stored on the computer readable medium and configured upon execution by at least one processing unit to perform any of the aforementioned methods.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example implementations of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 illustrates an example infill development prediction system suitable for implementation of various technologizes and techniques described herein.

FIG. 6 is a graph illustrating separation between a child well and three parent wells.

FIG. 7 is a flowchart of an example extract, transform and load process performed on unstructured data by the infill development prediction system of FIG. 5.

FIG. 8 is an example visualization generated by the infill development prediction system of FIG. 5.

FIG. 9 is a flowchart of an example parent feature aggregation mechanism used by the infill development prediction system of FIG. 5.

### DETAILED DESCRIPTION

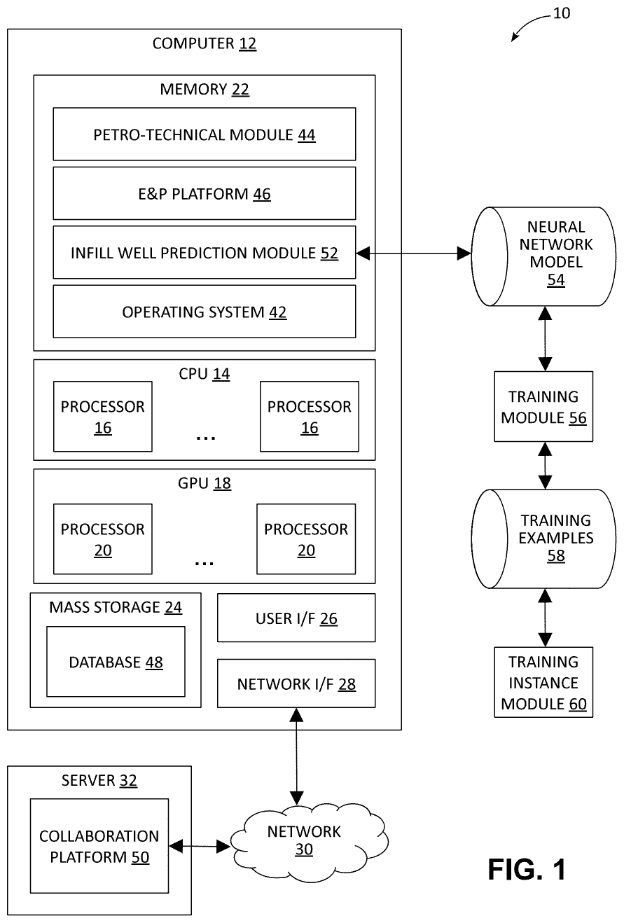

Turning now to the drawings, wherein like numbers denote like parts throughout the several views, FIG. 1 illustrates an example data processing system 10 in which the various technologies and techniques described herein may be implemented. System 10 is illustrated as including one or more computers 12, e.g., client computers, each including a central processing unit (CPU) 14 including at least one hardware-based processor or processing core 16 as well as a graphics processing unit (GPU) 18 including at least one hardware based processor or processing core 20, e.g., as may be implemented in integrated graphics or in an external adapter card. CPU 14 is coupled to a memory 22, which may represent the random access memory (RAM) devices comprising the main storage of a computer 12, as well as any supplemental levels of memory, e.g., cache memories, non-volatile or backup memories (e.g., programmable or flash memories), read-only memories, etc. In addition, memory 22 may be considered to include memory storage physically located elsewhere in a computer 12, e.g., any cache memory in a microprocessor or processing core, as well as any storage capacity used as a virtual memory, e.g., as stored on a mass storage device 24 or on another computer coupled to a computer 12.

Each computer 12 also generally receives a number of inputs and outputs for communicating information externally. For interface with a user or operator, a computer 12 generally includes a user interface 26 incorporating one or more user input/output devices, e.g., a keyboard, a pointing device, a display, a printer, etc. Otherwise, user input may be received, e.g., over a network interface 28 coupled to a network 30, from one or more external computers, e.g., one or more servers 32 or other computers 12. A computer 12 also may be in communication with one or more mass storage devices 24, which may be, for example, internal hard disk storage devices, external hard disk storage devices, storage area network devices, etc.

A computer 12 generally operates under the control of an operating system 42 and executes or otherwise relies upon various computer software applications, components, programs, objects, modules, data structures, etc. For example, a petro-technical module or component 44 executing within an exploration and production (E&P) platform 46 may be used to access, process, generate, modify or otherwise utilize petro-technical data, e.g., as stored locally in a database 48 and/or accessible remotely from a collaboration platform 50. Collaboration platform 50 may be implemented using multiple servers 32 in some implementations, and it will be appreciated that each server 32 may incorporate a CPU, memory, and other hardware components similar to a computer 12.

In one non-limiting implementation, for example, E&P platform 46 may implemented as the PETREL Exploration & Production (E&P) software platform, while collaboration platform 50 may be implemented as the STUDIO E&P KNOWLEDGE ENVIRONMENT platform, both of which are available from Schlumberger Ltd. and its affiliates. It will be appreciated, however, that the techniques discussed herein may be utilized in connection with other platforms and environments, so the invention is not limited to the particular software platforms and environments discussed herein.

In many implementations, computer 12 includes an infill well prediction model 52 that can be utilized in connection with predicting various aspects associated with an existing or proposed infill well. Module 52, as will be discussed in greater detail below, may incorporate one or more machine learning or neutral network models 54, and in connection with training such models, a training module 56 may utilize one or more training examples 58 generated by a training instance module 60, as will also be discussed in greater detail below.

In general, the routines executed to implement the implementations disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more hardware-based processing units in a computer (e.g., microprocessors, processing cores, or other hardware-based circuit logic), cause that computer to perform the steps embodying desired functionality. Moreover, while implementations have and hereinafter will be described in the context of fully functioning computers and computer systems, those skilled in the art will appreciate that the various implementations are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific implementation of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, and/or supplemented with other techniques known in the art, and therefore, the invention is not limited to the particular sequences of operations described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

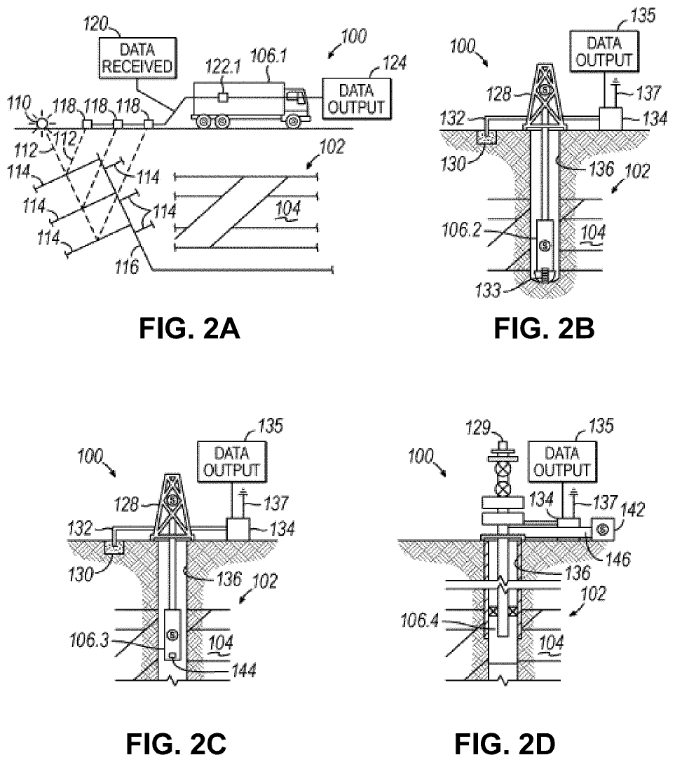

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

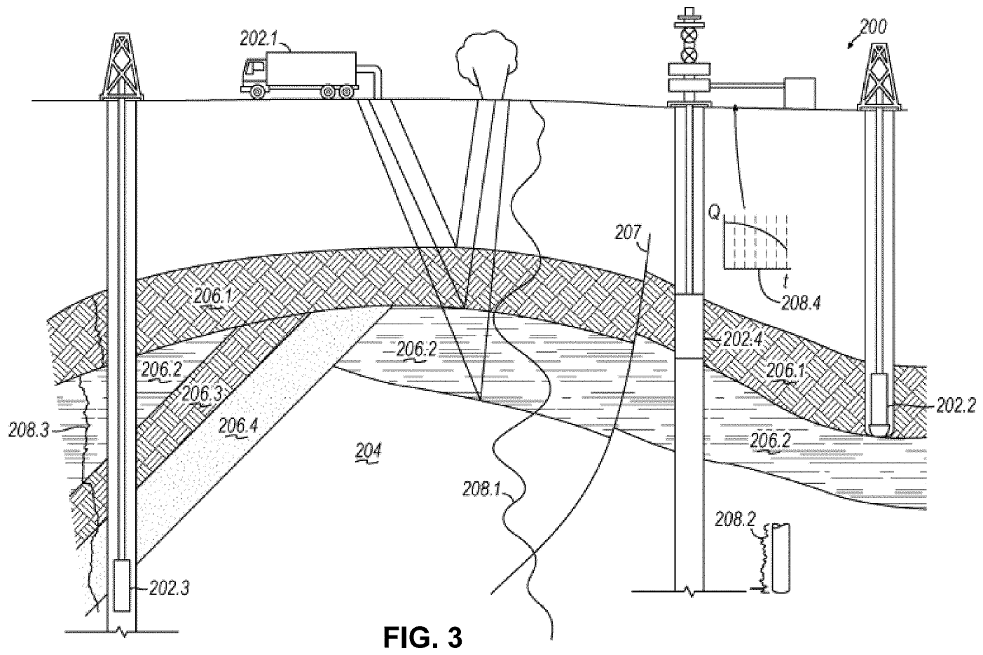

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

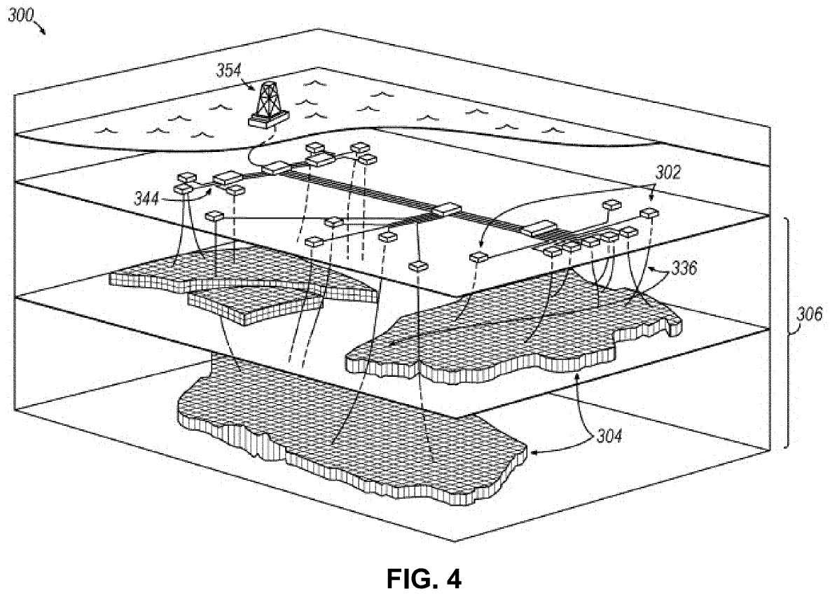

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Infill Well Prediction

In many unconventional hydrocarbon basins, development initially proceeds by drilling a limited number of wells suitable for covering a particular acreage. These initial wells are sometimes referred to as parent wells. Development thereafter proceeds by drilling additional infill wells, also referred to as child wells, and in many instances, the child wells are subjected to stimulation operations to stimulate production in the infill wells. However, when a child well stimulation operation communicates with a parent well, the result is parent-child well interference, which may be referred to additionally as a frac hit, and such frac hits can have positive, negative, or neutral effects on parent well production. In addition, infill well production generally varies with distance from the parent well, the time elapsed since the parent well began producing, and other factors. Rapid production declines may also occur in parent and child wells after infill well stimulation.

Infill drilling accounts for more than 60% of the new wells drilled in North America, making it more important than ever to follow a consistent and holistic process of planning, designing, constructing, completing, and producing such wells. Infill wells are often drilled near or between existing producer wells to replace reserves as the original well production declines. But the reservoir pressure declines as the original wells produce, changing the reservoir properties and complicating infill well development—especially as well spacings decrease.

Previously, the challenge of planning unconventional infill wells has been approached using a technically advanced model-based approach that relates input parameters across subsurface, drilling, completion and stimulation to output well. However, such approaches generally can take months of domain expert time to build. Attempts have been made to perform rapid data driven evaluation based on publicly available data employing only a small number of the input parameters to predicted output well production, modeling a limited number of wells specific to a play or client.

However, optimizing infill well development has been found to require focused attention to practices across the full lifecycle of the well: from planning and design through construction, stimulation, and production, and potentially involving assimilating and modeling the effects of various subsurface, petrophysics, geology, drilling, completion, stimulation and production factors and understanding optimal well spacing, optimize proppant quantity, characterize frac hit interaction and inferring impact of child on parent wells.

In the embodiments discussed herein, a proposed workflow is presented for taking a holistic exploration-to-production, data driven approach to predict optimum, economic infill well performance and quantify frac-hit effect across potentially hundreds of thousands of well pairs in the basin using cross-domain data. In some embodiments, big data, natural language processing (NLP) and machine learning (ML) techniques utilize various types of structured and unstructured information collected across one or more of reservoir, drilling, completion, production, chemicals residing in databases and operational reports by combining structured tabular data with facts extracted from reports using NLP techniques, training machine learning algorithms to learn interaction across well pairs and driving insights into design parameters that influence parent and child well performance. Such an approach can, for example, assist with quantifying the production impact of parent well depletion on an infill well with a purpose to mitigate the interference, optimize infill well development and production and/or determine actions that may be taken to maximize returns from child wells.

In particular, in some embodiments consistent with the invention, data associated with a plurality of wells in a basin may be used to build a plurality of well pairs that describe parent-child relationship between pairs of wells in the basin. Each well pair, for example, may match a pair of wells as parent and child, and may include one or more parameters associated with the parent-child pair relationship between the wells. At least some of the parameters of at least some of the well pairs may then be provided to a machine learning model for training and/or use of the machine learning model to predict a production impact of an infill well (which may be an existing well in some instances or may be a planned well in other instances) on one or more neighboring wells among the wells in the basin.

As noted above, from the perspective of a parent-child relationship between two wells, the parent well is generally a well that has been drilled and completed prior to completion of the child well. As will become more apparent below, various parameters associated with that relationship may be generated and/or used, including, for example, distance parameters that describe the positional differences between the wells (e.g., various distances such as mid-point to mid-point distances, minimum distances, etc.), temporal parameters such as completion date differences between the wells, the number of months of production of a parent well prior to a child well completion, production parameters such as parent well production over time (including before and after child well completion), child well production over time, etc. These parameters may be considered in some embodiments to be pair level parameters, and in some embodiments, for example, a parameter such as a three month production impact parameter, which describes an average monthly production for the parent well for three months before and after child well completion, may be used to quantify the impact of the child well on the parent well for the well pair, and may be used to train and/or use one or more machine learning models (e.g., a production impact model and/or a well performance model, described in greater detail below). It will be appreciated, however, that other pair level parameters may be used in other embodiments, so the invention is not limited to this particular type of parameter.

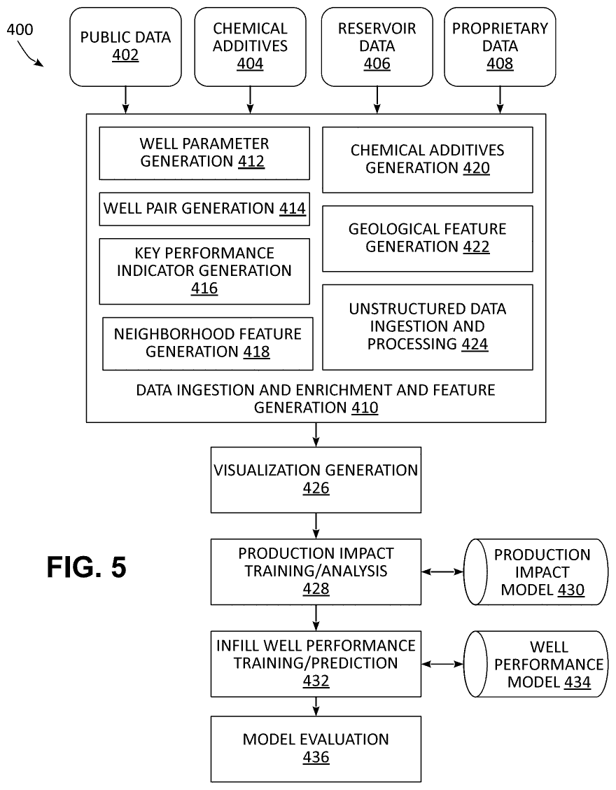

Now turning to FIG. 5, this figure illustrates an example data flow and model training pipeline 400 for implementing the various techniques disclosed herein. Workflow 400 is based in part on four primary categories of data, including public data 402, chemical additives data 404, reservoir data 406 and proprietary data 408. Public data 402 includes, for example, publicly-available information on geographical, well, drilling, production, and completion parameters, while chemical additives data 404 includes, for example, hydraulic fracturing chemical additives information such as diverters, clays, surfactants, etc. Reservoir data 406 includes, for example, geology, structure, and petrophysics data. Proprietary data 408 includes, for example, frac reports, drilling reports, and Log ASCII Standard (LAS) files. Some implementations may incorporate additional or different data than that illustrated in FIG. 5, and some of the data mentioned above may not be used in some instances.

It will be appreciated that historically, infill well research has been conducted with public datasets given the sheer number of wells needed to identify production patterns. In some embodiments consistent with the invention, however, proprietary data 408 is used to enhance public datasets, thereby adding a new layer of complexity. Moreover, as homogeneity with current public datasets is almost never the case, the proprietary data 408 may also be converted to a compatible data model for integration into a common workflow. In addition, in some instances, some data, particularly proprietary data, may not only be incompatible with public datasets, it may also be unstructured, and thus may have no clear data model and may be distributed across several different types of documents. To address these and other issues, it may be desirable in some embodiments to create an “ideal” data model, and then search the dataset for desired parameters of the model in order to convert unstructured data into structured data. Structuring such data in some embodiments may incorporate an Extract, Transform and Load (ETL) process as is described in greater detail below.

The aforementioned data may initially be processed by a data ingestion and enrichment and feature generation module 410, which performs a number of different operations (represented by blocks 412-424) on the data to prepare the data for use in training and/or using machine learning models to predict infill well performance.

Block 412, for example, generates well description parameters, e.g., using an IHS Markit database or other database with publicly-available information such as is available in Wells, Completions, Production_Well, Survey_Point, Production Headers, Ip_Cum_Norm_Values, Production_Abstract, and Production tables. The information from such tables may be combined with domain rules as well as geometric methods to generate various features for every well. Outliers may also be removed based on domain and/or statistics.

Block 414 generates well pairs, including generating inter-well parameters and calculating distances. For calculating well pairs, each well in the processed data may be matched with each other well to form a parent-child pair relationship, thereby generating a plurality of candidate well pairs. Then, for each pair relationship, various pair level or inter-well parameters, e.g., key performance indicators (KPIs) may be generated for at least a subset of these candidate well pairs. One such type of KPI is a midpoint to midpoint distance, e.g., the distance between the parent well midpoint (latitude, longitude) and the child well midpoint (latitude, longitude). Another type of KPI is a minimum inter-well distance, e.g., the distance between the closest points in the two wells as line segments. Another type is a completion date difference, while another type is a cumulative total months of production for the parent well before the child well was completed. An additional KPI that may be used in different embodiments includes child-parent relative angle, among others.

In some embodiments, features with missing values may be sourced by joining multiple datasets together with the key as Well UWI to ensure maximum data coverage. Furthermore, using the filtered well pairs many new features such as Azimuth, Direction, Production Zone, etc. may also be inferred with the existing features available as a part of the data. Well pair features such as Cumulative Production of the Parent Well until Infill, Well Completion Date, Completion Date Difference between parent and child in a well pair, etc. may also be derived using filtered well pair features.

After calculating one or more of such KPIs, candidate well pairs may be selectively filtered or removed, e.g., to remove candidate well pairs having distances more than some threshold (e.g., 10,000 ft) and/or to remove candidate well pairs where the parent well was not completed before the child well. Thus, block 414 generates a set of well pairs of parent and child wells that meet temporal and/or spatial filter criteria or constraints, and excludes other well pairs not meeting those filter criteria or constraints from the generated set. It will be appreciated that other distance and/or temporal parameters, as well as other non-distance and non-temporal parameters, may be used to filter candidate well pairs. In addition, other distance, temporal, or other criteria may be applied to such parameters to filter candidate well pairs in other embodiments.

Block 416 generates one or more key performance indicators (KPIs). In particular, in order to statistically determine the impact of an infill well onto the parent wells around it, one or more KPIs may be selected to quantify the impact. In one example embodiment, a three month production impact on the parent well, which describes production by the parent well before and after completion of the child well, may be used as a KPI for frac hits. The calculation may be performed in some embodiments as follows:

1. For each well pair, obtain the average monthly production of the parent well three months before and three months after the child well completion date.

2. If there are any missing months due to shut in either before or after child well's completion, record such instances and find the next available month.

3. If there is no data either before or after a child well's completion date for more than six months, the well pair may be rejected as not fitting the frac hit criterion.

Block 418 generates neighborhood features. After generating most of the well and intra-well features, as well as the production impact KPI (e.g., three month production), various neighborhood features may be generated and analyzed. The feature in some embodiments may be based at least in part on:

1. Reciprocal of the midpoint to midpoint distance of a parent well from a child well in consideration (A);

2. A total proppant pumped on a parent well (B);

3. A total of cumulative months that a parent well produced before the child well was completed (C); and

4. A total oil production for a parent well before a child well completion (D).

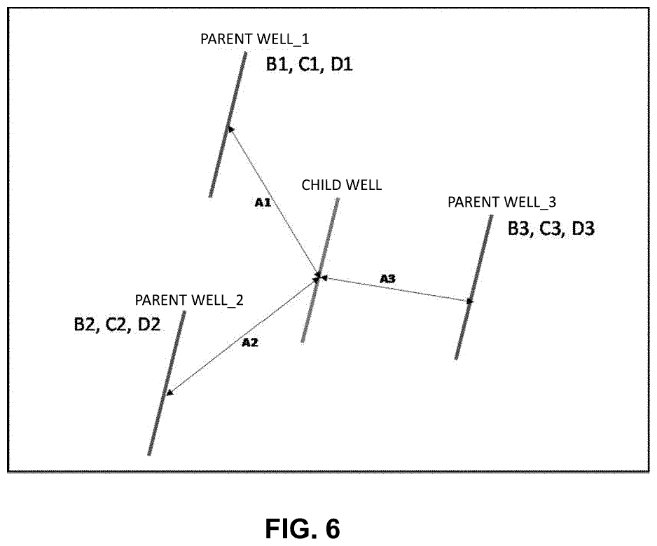

This is represented in FIG. 6. This feature may be combined into one feature per parent well by calculating the net contribution of every parent well compared to all the other parent wells for a given child well. While other calculations may be used in other embodiments, one suitable calculation may operate as follows. For a child well (CH), first calculate A, B, C, D for every parent well of CH as mentioned above. Then, for every parent of this child Pᵢ, the Neighborhood Contribution (NC) may be calculated as:

N.C. Of Pᵢ=(Aᵢ*Bᵢ*Cᵢ*Dᵢ)/Σ((Aᵢ*Bᵢ*Cᵢ*Dᵢ) for all parents of child CH)

Block 420 generates chemical additive information. In some embodiments, for example, such information may be generated by collecting from various publicly available sources various features representing chemical additives used during stimulation treatments, such as surfactants, clay stabilizers, etc.

Block 422 generates geological features. In some embodiments, for example, such information may be generated by collecting from various publicly available sources various features describing various elements of the reservoir, such as gross height, porosity, water saturation, etc.

Block 424 ingests and processes unstructured data. In particular, in some embodiments, beyond gathering and preparing data from structured datasets for the machine learning models, unstructured datasets may also be used to complement the structured data sets. Proprietary data (i.e., data not widely available in publicly-available databases, may be collected and organized into directories, e.g., organized by wells and containing documents regarding drilling, stimulation and/or geology. In some instances, an unstructured dataset may include various Log ASCII Standard (LAS) files, PDF files, word processing documents and/or spreadsheets, etc. In some instances, inside each well directory there may be a somewhat consistent structure for the files; however, in many cases, it may be desirable to perform searching to extract suitable information for use in connection with the herein-described techniques.

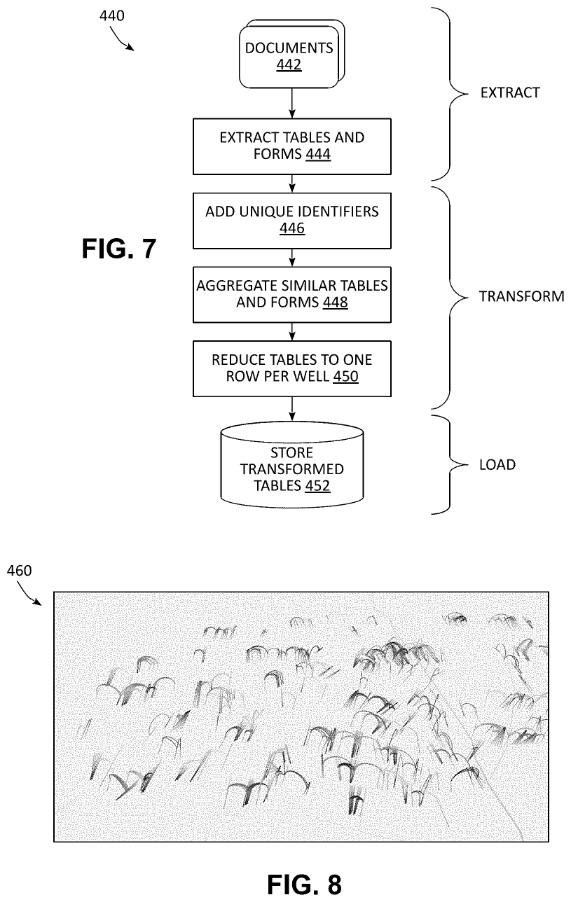

It is generally desirable to format the unstructured data into a structured format to provide the data in a suitable format for a machine learning algorithm. Thus, in some embodiments it may be desirable to focus on tables and forms (key-value pairs), and to use a multi-step pipeline using Extract, Transform and Load (ETL) steps as illustrated at 440 in FIG. 7.

In the extract step (block 444), one or more documents 442 may be analyzed by a crawler algorithm to determine what information can be extracted from each document. Then, compatible files may be forwarded to one or more rule-based algorithms for table and/or form extraction, resulting in the generation of individual raw extracted tables and forms as separate entities, e.g., with tables in a Row-Column format and forms in a Key-Value pair format.

In the transform step, each individual table and form may be read by a rule-based algorithm, which first matches similar table and form headers through approximate (fuzzy) string comparison and aggregates similar tables adding extra columns to determine unique identifiers such as a well name for all entities, a frac stage number for frac entities and a depth for drilling and geological entities (block 446). This process may also, in some embodiments, incorporate manual inspection to check if tables and forms are matched properly. In the same step, further aggregation may be performed (blocks 448 and 450) to make the data more readily consumable by machine learning algorithms, e.g., with each well having exactly one row in the final table so statistical measures such as maximum, minimum, variance and averages may be employed to reduce the data further. The transform step in some embodiments may output a set of tables with all the raw data aggregated and the table used for the machine learning algorithms where each well corresponds to one row in the table. This table in some embodiments may include frac (stimulation), drilling and geological parameters.

The load step of the pipeline (block 452) may then store all the tables generated in the transform step as Row-Column values in a Structured Query Language (SQL) database to be used by various other steps of the approach. Various types of KPIs may be generated from unstructured and/or structured data in different embodiments, and used to train and/or use the machine learning models, including, without limitation, total clean fluid, total slurry volume, total proppant mass, average pumping rate, average stage concentration, top and bottom perforations, total perforated lateral length, number of stages, number of clusters/stage, proppant intensity, average treating pressure, average instantaneous shut-in pressure, average frac gradient, etc.

Returning to FIG. 5, and with specific reference to block 426, it may be desirable in some embodiments to generate one or more visualizations for use in connection with the herein-described process. In some embodiments, a geographic data visualization tool may be used, e.g., the open source Kepler tool available from Uber, which is built on Web.gl. Such visualization may be used to readily analyze a cluster of wells in an area and see the effect of parent child pairs directly by plotting their impact as arcs between the wells. FIG. 8, for example, illustrates an example visualization 460 that may be used in some embodiments.

Returning again to FIG. 5, two machine learning models may desirably be trained and/or used in some embodiments. Block 428, for example, may be used to train a production impact model 430 and/or analyze production impact using model 430. Model 430, for example, may be used to model parent well and child well interference and production impact with a chance of occurrence, e.g. using the generated features mentioned above as independent variables. In some embodiments, an average three month production value of a parent well, before and after stimulation of a child well, may be used to derive a short-term frac hit impact of the child well, which may be used to calculate a relative increase or decrease of the parent well production for every well pair. For example, using generated KPI as labels and sets of processed features for the well pairs, a supervised regression problem may be defined, and well pair features may be used as an input to a machine learning model to infer relative increase or decrease in production of the parent well in the well pair being considered. The output of the model may therefore be the aforementioned three month oil production impact KPI for a parent well. While a number of different machine learning models may be used in different embodiments, one suitable model that may be used in some embodiments is a tree based boosting algorithm such as Xgboost (with a max_depth=15). It will be appreciated that the net contribution by every parent well as explained above may act as a confidence threshold for augmenting the model prediction and assisting in decision making. In some embodiments, inputs to model 430 may include, for example, midpoint to midpoint distance, cumulative gas production, cumulative water production, minimum inter-well distance, cumulative liquid production, averaged true vertical depth difference, gas/oil ratio (GOR), total proppant, bearing, completed date difference, latitude and longitude gross perforation interval, total organic carbon, and/or total proppant per total fluid.

Similarly, block 432 may be used to train a well performance model 434 and/or predict infill well performance using model 434. Model 434, for example, may use many of the same features discussed above as well as additional generated values for each child well in some embodiments, e.g., to forecast cumulative production over a time frame (e.g., 12 months). While a number of different machine learning models may be used in different embodiments, one suitable model that may be used in some embodiments is a tree based boosting algorithm such as Xgboost (with a max_depth=15), similar to the tree based boosting algorithm used for model 430. In some embodiments, inputs to model 432 may include, for example, cumulative liquid mean, child TOC (AC), midpoint to midpoint distance, child TOC (AC), latitude and longitude gross perforation interval, bearing, child bearing, cumulative water mean, minimum inter-well distance mean, cumulative 12 month oil production mean, child total proppant, volume calcite (AC) mean, cumulative 12 month gas production mean, child total fluid, cumulative 12 month water production mean, GOR, date fracked, and/or child total proppant per total fluid.

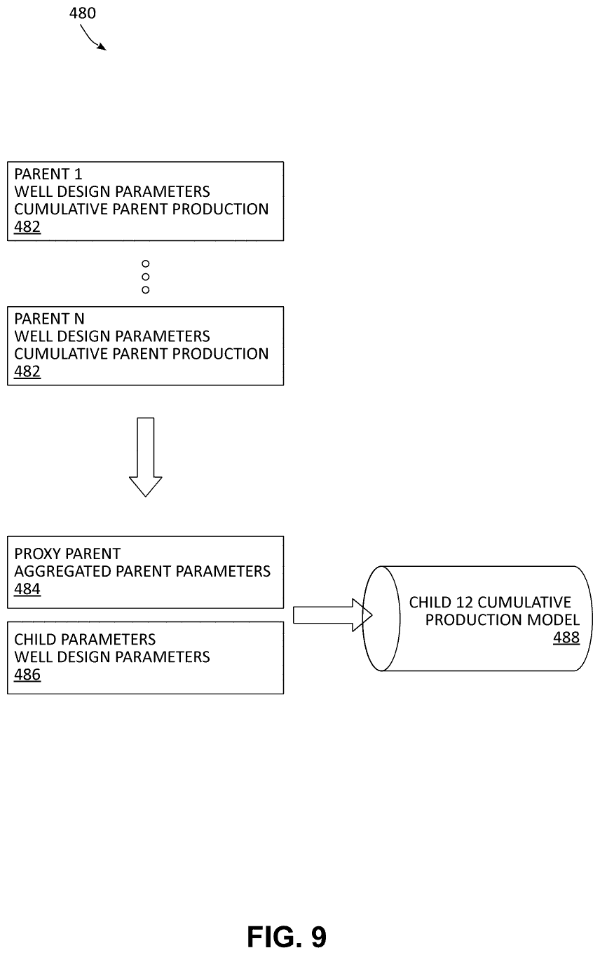

In some embodiments, a 12 month cumulative performance of an infill well may be used as a label and all the raw features of all the surrounding parent wells within some distance (e.g., ˜10,000 ft) as well as the features of the infill wells together may be used to develop a supervised machine learning model that can estimate 12 months cumulative child well production. It will be appreciated that using all of the features for all of the parents of an infill well will generally create a very large set of redundant features for all the parents, and due to varying numbers of parents in every child well there will be varying numbers of features per child, which can be cumbersome for model training purposes. To overcome this problem, an aggregation mechanism such as illustrated at 480 in FIG. 9 may be used in some embodiments to convert all the parent features 482 for parent wells in the neighborhood of the child into a single, proxy parent 484 that provides a collective factors of all the features impacting a child well. While the aggregation may suppress some information, it nonetheless provides a unique opportunity to model the parent and child well features together, thus accounting for the interactive effect between both wells. When combined with child parameters 486 therefore a child 12 cumulative production (well performance) model 488 may be developed.

Returning to FIG. 5, it may also be desirable in some embodiments to perform model evaluation (block 436), e.g., by performing analysis to identify various metrics suitable for validating the models, including, for example, Mean Absolute Error and R2 Score (also known as Explained Variance Score).

Training of models 432, 434 may, in some embodiments, use a time stratified train test split with 80% of child wells in the past and all of their parent wells for training and the rest used for testing and validation. In addition, while gradient boosting trees are used in the illustrated embodiments, other algorithms may be used in other embodiments, e.g., Linear Regression, Lasso Regression, Decision Trees, Random forests, Neural Networks, etc. Hyperparameter optimization may also be performed in some embodiments to optimize L1 and L2 regularization and the learning rate with an early stopping mechanism to prevent overfitting on the data.

In one example embodiment, 40,000 wells in the Gulf Coast basin were analyzed, generating approximately 650,000 well pairs. Approximately 90 features comprising raw and calculated metrics from the above-mentioned data sources were included in the analysis, and based on initial analysis of the processed final dataset it was found that the dataset had about 15-20% missing or erroneous values, which were removed or inferred using domain/statistical heuristics. For this dataset, a Mean Absolute Error of about 10% as well as a R2 Score of about 0.73 was obtained.

It will be appreciated that the herein-described techniques may have a broad range of workflow applications. Predicting the production impact, either positive, negative, or neutral, of an existing parent well due to the stimulation treatment of a new well in close proximity, is generally a daunting task, and typical physics-driven methods generally require a broad and complex set of data, yet still often lack the precise ability to explicitly make this determination. In addition, a very high level of knowledge and expertise are generally required to run such models and even with cloud-enabled solutions, still take a significant amount of time to fully run.

In contrast, the herein-described techniques may provide operators, analysts, engineers, etc. with necessary and/or critical insights in a more efficient manner to enable positive impact on a wide array of activities, e.g., in unconventional shale development. Examples of how these techniques may be applied include, but are not limited to:

1. Infill Well Planning and Design: For a given set of parameters, determine the well spacing, sequencing, stacking, and count coupled with the optimal job design parameters that maximize the expected production and economic indicators.

2. Real time job optimization: Integrate with a real-time optimization framework to rapidly provide optimal insights to enhance the deployment and execution of various technologies to optimize infill well stimulation operations in real time.

3. Type Curve Generation: Quickly generate infill well specific type curves that take into account well interference on future completed wells.

4. Well Inventory Evaluation: Time-dependent well spacing optimization to determine remaining hydrocarbons in place and volumetrics, and resulting potential well locations for given economic conditions.

5. Asset Evaluation: Determine true economic potential of an existing asset to be utilized during asset and divestiture processes.

It will be appreciated that the herein-described techniques may be deployed in some embodiments as an individual, stand-alone cloud-based application to quickly provide immediate insights for planning or ongoing operations, or as part of a holistic integrated platform to for more rigorous, end-to-end optimization across the entire well life cycle.

Although the preceding description has been described herein with reference to particular means, materials, and implementations, it is not intended to be limited to the particular disclosed herein. By way of further example, implementations may be utilized in conjunction with a handheld system (i.e., a phone, wrist or forearm mounted computer, tablet, or other handheld device), portable system (i.e., a laptop or portable computing system), a fixed computing system (i.e., a desktop, server, cluster, or high performance computing system), or across a network (i.e., a cloud-based system). As such, implementations extend to all functionally equivalent structures, methods, uses, program products, and compositions as are within the scope of the appended claims. It will also be appreciated that training and/or utilization of machine learning models based upon the techniques described herein would be well within the abilities of those of ordinary skill having the benefit of the instant disclosure. In addition, while particular implementations have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

What is claimed is:

1. A method, comprising:
receiving data associated with a plurality of wells in a basin;
building a plurality of well pairs from the received data, wherein each well pair in the plurality of well pairs matches a pair of wells from among the plurality of wells in a parent-child pair relationship and includes one or more parameters associated with the parent-child pair relationship; and
providing the one or more parameters of at least a portion of the plurality of well pairs to a trained machine learning model to predict a production impact of an infill well on one or more neighboring wells among the plurality of wells in the basin.

2. The method of claim 1, wherein the infill well is an existing infill well.

3. The method of claim 1, wherein the infill well is a planned infill well.

4. The method of claim 1, wherein building the plurality of well pairs includes:
generating a plurality of candidate well pairs from the plurality of wells;
determining one or more pair level parameters for at least a subset of the plurality of candidate well pairs; and
filtering the plurality of candidate well pairs using the determined one or more pair level parameters to determine the plurality of well pairs.

5. The method of claim 4, wherein the determined one or more pair level parameters for a first well pair in the plurality of candidate well pairs includes at least one distance parameter describing a distance between the wells in the first well pair, and wherein filtering the plurality of candidate well pairs includes applying a distance filter criterion to accept or reject the first well pair based upon the at least one distance parameter.

6. The method of claim 4, wherein the determined one or more pair level parameters for a first well pair in the plurality of candidate well pairs includes at least one temporal parameter describing a temporal relationship between the wells in the first well pair, and wherein filtering the plurality of candidate well pairs includes applying a temporal filter criterion to accept or reject the first well pair based upon the at least one temporal parameter.

7. The method of claim 1, wherein each of the plurality of well pairs includes a parent well and a child well.

8. The method of claim 7, wherein the one or more parameters associated with the parent-child pair relationship for each of the plurality of well pairs includes a key performance indicator describing production by the parent well before and after completion of the child well.

9. The method of claim 7, further comprising generating one or more neighborhood features describing, for each of a plurality of child wells, a net contribution of each of a plurality of neighboring parent wells to each such child well, and wherein providing the one or more parameters to the trained machine learning model to predict the production impact of the infill well on the one or more neighboring wells further includes providing the one or more neighborhood features to the trained machine learning model.

10. The method of claim 1, wherein receiving the data includes receiving one or more of public data, chemical additives data, reservoir data or proprietary data, and wherein providing the one or more parameters to the trained machine learning model to predict the production impact of the infill well on the one or more neighboring wells further includes providing the one or more of public data, chemical additives data, reservoir data or proprietary data to the trained machine learning model.

11. The method of claim 10, wherein receiving the data includes receiving unstructured data, the method further comprising:
extracting a plurality of tables and/or forms from the unstructured data;
matching similar table and/or form headers to aggregate similar tables and/or forms in the plurality of tables and/or forms; and
after aggregating similar tables and/or forms in the plurality of tables and/or forms, generating a plurality of rows, with each row including stimulation, drilling and/or geological data from the plurality of tables and/or forms and associated with a single well among the plurality of wells.

12. The method of claim 1, wherein the trained machine learning model comprises a production impact model.

13. The method of claim 12, further comprising providing at least a portion of the one or more parameters of at least a portion of the plurality of well pairs to a second trained machine learning model to predict a performance of the infill well.

14. The method of claim 13, wherein the second trained machine learning model comprises a well performance model.

15. The method of claim 1, wherein each of the plurality of well pairs includes a parent well and a child well, the method further comprising, for each of a plurality of child wells, aggregating parent well features for a plurality of parent wells in a neighborhood of such child well into a proxy parent representing a collective impact on such child well, wherein providing the one or more parameters to the trained machine learning model to predict the production impact of the infill well on the one or more neighboring wells further includes providing one or more proxy parents to the trained machine learning model.

16. An apparatus, comprising:
a computing system including one or more processors; and
program code configured upon execution by the one or more processors of the computing system to perform a method, comprising:
receiving data associated with a plurality of wells in a basin;
building a plurality of well pairs from the received data, wherein each well pair in the plurality of well pairs matches a pair of wells from among the plurality of wells in a parent-child pair relationship and includes one or more parameters associated with the parent-child pair relationship; and
providing the one or more parameters of at least a portion of the plurality of well pairs to a trained machine learning model to predict a production impact of an infill well on one or more neighboring wells among the plurality of wells in the basin.

17. The apparatus of claim 16, wherein building the plurality of well pairs includes:
generating a plurality of candidate well pairs from the plurality of wells;
determining one or more pair level parameters for at least a subset of the plurality of candidate well pairs; and
filtering the plurality of candidate well pairs using the determined one or more pair level parameters to determine the plurality of well pairs.

18. The apparatus of claim 17, wherein the determined one or more pair level parameters for a first well pair in the plurality of candidate well pairs includes at least one distance parameter describing a distance between the wells in the first well pair, and wherein filtering the plurality of candidate well pairs includes applying a distance filter criterion to accept or reject the first well pair based upon the at least one distance parameter.

19. A program product, comprising:
a non-transitory computer-readable medium; and
program code stored on the non-transitory computer-readable medium and configured upon execution by a computing system including one or more processors to perform a method, comprising:
receiving data associated with a plurality of wells in a basin;
building a plurality of well pairs from the received data, wherein each well pair in the plurality of well pairs matches a pair of wells from among the plurality of wells in a parent-child pair relationship and includes one or more parameters associated with the parent-child pair relationship; and
providing the one or more parameters of at least a portion of the plurality of well pairs to a trained machine learning model to predict a production impact of an infill well on one or more neighboring wells among the plurality of wells in the basin.

20. The program product of claim 19, wherein building the plurality of well pairs includes:
generating a plurality of candidate well pairs from the plurality of wells;
determining one or more pair level parameters for at least a subset of the plurality of candidate well pairs; and
filtering the plurality of candidate well pairs using the determined one or more pair level parameters to determine the plurality of well pairs.
